(19) United States
(12) Patent Application Publication
(10) Pub. No.: US 2003/0102065 A1
(43) Pub. Date: Jun. 5, 2003

(54) Clamping device for a snow chain

(76) Inventors: Thomas Picher, Graz (AT); Erwin Bertalanic, Kapfenberg (AT)

Correspondence Address: Paul D Greeley, Ohlandt Greeley Ruggiero & Perle, 10th Floor, One Landmark Square, Stamford, CT, 06901-2682, US

(21) Appl. No.: 10/240,975

(22) PCT Filed: Apr. 6, 2001
(86) PCT No.: PCT/AT01/00101

(30) Foreign Application Priority Data
Apr. 10, 2000 (AT) A 606/2000

(51) Int. Cl. B60C 11/00

(52) U.S. Cl. 152/214

(57) ABSTRACT

The invention concerns a clamping device for a nonskid tire chain with a housing and an actuation member, which has a lock-in position, in which a clamping cord which can be pulled into the housing through an opening in the housing, can be blocked counter to its clamping direction, as well as a release position, in which the blocking is canceled, and the clamping cord within the housing is connected to a winding roller preclamped in the winding-up direction, which [roller] is mounted so that it can rotate around its axis, whereby a ratchet wheel at the winding roller is provided with at least one spring-loaded safety catch assigned to it, and a second ratchet wheel is provided with a spring-loaded safety catch assigned to it, and the two ratchet wheels are joined with one another in a way that resists rotation, whereby the blocking directions of the ratchet wheels are opposite directions, and the spring-loaded safety catches of the first or the second ratchet wheel can be engaged reciprocally with the ratchet wheel belonging thereto by means of a common actuation member.

The invention concerns a clamping device for a nonskid tire snow chain with a housing and an actuation member, which has a lock-in position, in which a clamping cord that can be pulled into the housing through an opening in the housing can be blocked counter to its clamping direction, as well as a release position, in which the blocking is canceled, and the clamping cord is connected inside the housing to a winding roller which is preclamped in the winding-up direction, which [roller] is mounted so that it can rotate around its axis, and wherein a ratchet wheel on the winding roller is provided with at least one spring-loaded safety catch assigned to it.

Clamping devices are used in nonskid tire chains in order to avoid an undesired reverse motion of the clamping cord counter to the clamping direction after mounting.

Such a clamping device is presented in DE 297 03 911 U1. In this clamping device, a housing is provided, in which the clamping cord can be wound up on a winding drum, which is joined in a rotation-resistant manner with a ratchet wheel. The winding drum is preclamped by a spring in order to wind up the clamping cord in the winding-up direction. The winding up of the clamping cord can be triggered by means of an actuation lever introduced outside on the housing. The relatively impractical handling of the actuation lever, which also can be easily gummed up with dirt or ice is a disadvantage in this device.

In addition, the length of the part of the clamping cord projecting out from the housing can only be poorly adjusted.

Thus, the object of the invention is to create a clamping device, which is simple to handle and also has a high ease of operation under adverse outside conditions.

This object is resolved with a clamping device of the type named initially according to the invention such that a second ratchet wheel is provided with a spring-loaded safety catch assigned to it, and the two ratchet wheels are joined together in a way that resists rotation, whereby the ratchet wheels are blocked in opposite directions and the spring-loaded safety catches of the first or of the second ratchet wheel can be reciprocally engaged with the respective ratchet wheel by means of a common actuation member.

It is a merit of the invention to create a simply constructed and robust clamping device, which is characterized above all by a high ease of operation, since the clamping cord can be alternately blocked and released in both of its directions of motion.

In a favorable variant of the invention, the two safety catches are arranged as mirror images with respect to a plane containing the axis of the winding roller.

In a preferred form of embodiment, the first ratchet wheel has a larger diameter than the second ratchet wheel.

Production can be simplified such that the two ratchet wheels are produced in one piece from an injection-molded piece.

A simple operability can be achieved in that the actuation member embraces the ratchet wheels and the safety catches are mounted outside the actuation member, whereby the actuation member has the form of a cylindrical sheath that is interrupted in certain places, thus making possible an engagement of the safety catches in the ratchet wheels.

In order to be able to easily handle the actuation member, projections are provided as handles, which project out from recesses in the housing surrounding the actuation member and the safety catches at the outer surface of the cylinder-shaped actuation member and lie above one another, these handles running essentially radially to the surface of the cylindrical sheath.

The operability of the actuation member can be further improved in that it is mounted so that it can be rotated in the housing around the axis of the winding roller.

In order to make possible a blocking and releasing of the ratchet wheels, the safety catches are mounted in the housing so that they can tilt around axes that are parallel to the axis of the winding roller.

The safety catches can be introduced very easily into their blocking position, due to the fact that a spring taken up in the recesses of the safety catches is provided at specific places in the mounting region in the housing for each safety catch.

The change in position of the safety catches is facilitated in that the safety catches have ascending surfaces cooperating with segments of the outer cylindrical surface on the sides of the safety catches turned toward the actuation member, and these ascending or leading surfaces disengage the ratchet wheels reciprocally against the respective spring by twisting or rotating the actuation member.

If the ratchet wheels are provided with different radii, then it is of advantage if the safety catch assigned to the first ratchet wheel that is larger in diameter has a raised part on its ascending surface, which serves for creating a sufficiently great distance between the ratchet wheel and the safety catch in the release position.

The invention as well as additional advantages will be explained in more detail below on the basis of an example of embodiment, which is illustrated in the drawing. Here:

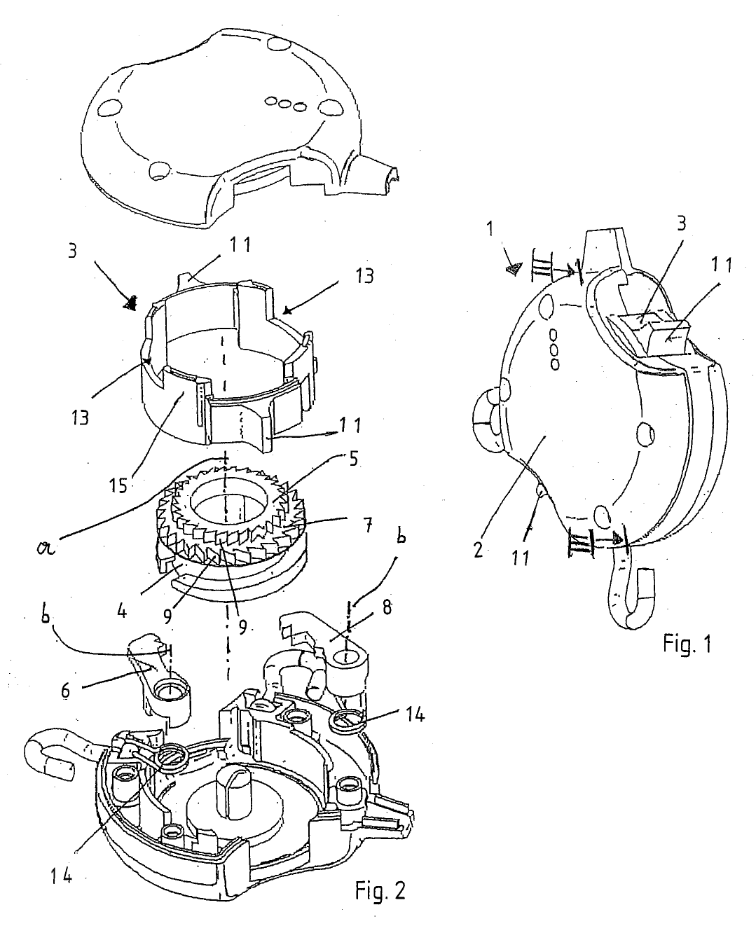

FIG. 1 shows a clamping device in perspective view according to the invention;

FIG. 2 shows a clamping device according to the invention in exploded representation;

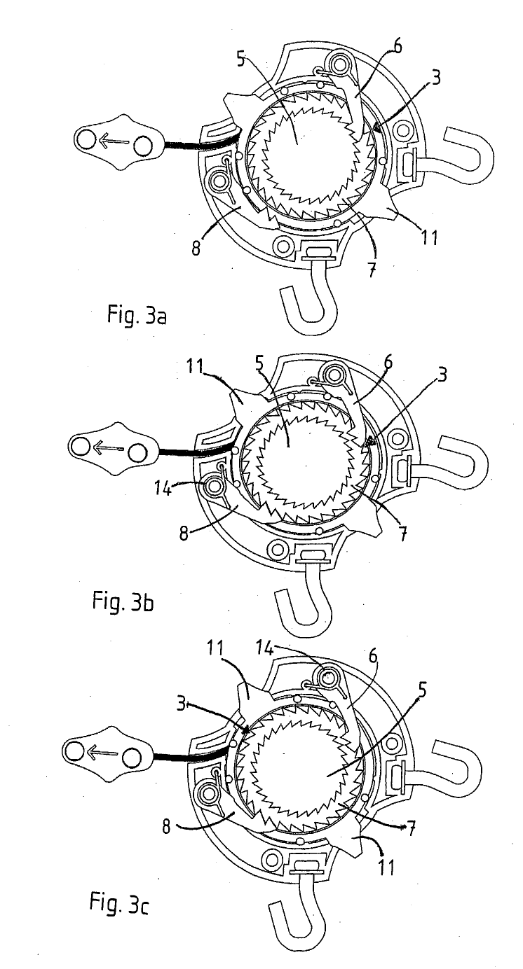

FIG. 3a-FIG. 3c show sections along line III-III in FIG. 1 in top view with different positions of the actuation member;

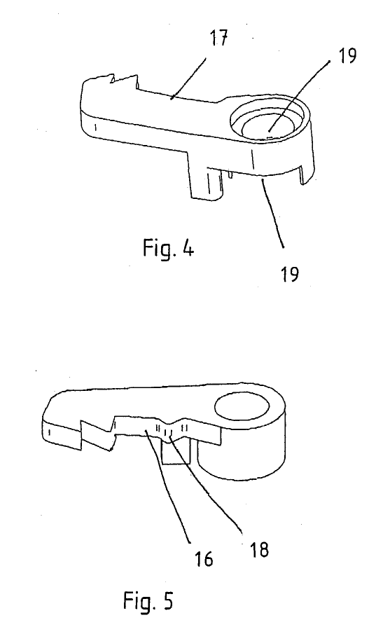

FIG. 4 shows a safety catch in perspective view;

FIG. 5 shows another safety catch in perspective view.

According to FIG. 1, a clamping device 1 according to the invention has a housing 2 with an actuation member 3 mounted so that it can be tilted. Openings for projections 11 of actuation member 3 are provided at places opposite one another in housing 2. The actuation member 3 can be tilted against housing 2 by means of these projections 11. The function of the actuation member 3 consists of releasing a clamping cord, which can be used for clamping a nonskid tire chain, in a desired direction as needed, and simultaneously blocking the opposite direction.

For blockade of a clamping cord in one direction while simultaneously releasing the clamping cord in the other direction, two ratchet wheels 5, 7, in which safety catches 6, 8 can engage in each of these wheels, are provided according to FIG. 2. In order to obtain different blocking directions of ratchet wheels 5, 7, they have ascending sides 9 inclined in opposite directions. Springs 14 serve for the purpose of bringing safety catches 6, 8 into a position, at which they block the ratchet wheel 5, 7 belonging thereto. In order to roll up the clamping cord, which is not shown for purposes of the drawing, in housing 2, a winding roller 4 is provided which is rigidly joined with the ratchet wheels 5, 7 and is preclamped in the winding-up direction by a spring that is not shown here. A thread-shaped surface profile is provided for guiding the clamping cord on winding roller 4.

The actuation member 3 embraces the ratchet wheels 5, 7 whereby each safety catch 6, 8 is mounted in a rotatable manner in housing 2 outside actuation member 3 around an axis b, which runs parallel to axis a of winding roller 4.

In order to facilitate the rotation of actuation member 3, the latter is substantially formed in the shape of a cylinder open at its cover surface and mounted in a rotatable manner around axis a of winding roller 4, whereby recesses 13 are provided on the cylindrical sheath in order to make possible an engagement of safety catches 6, 8 in ratchet wheels 5, 7.

By a rotation of actuation member 3 opposite housing 1, parts of the cylindrical sheathing 15 of actuation member 3 are displaced against ascending surfaces 16, 17 of safety catches 6, 8 shown in FIG. 4 and FIG. 5, whereby these catches can be pressed by springs 4 reciprocally into the ratchet wheel 5, 7 belonging thereto. The safety catches 6, 8 have recesses 19 shown in FIG. 4 and FIG. 5 for the successive uptake of springs 4*.

As can be seen from FIGS. 3a-3c, the clamping device 1 has two ratchet wheels 5, 7 with different diameters. This form of embodiment is characterized in that it is particularly simple to manufacture.

The safety catch 8, which is engaged in the larger ratchet wheel 7, as shown in FIG. 5, has a raised part 18 on its ascending surface. The reason for this measure consists of making sufficiently large the distance to the safety catch 8 in the release position, as shown in FIG. 3a, which has been reduced due to the larger radius of ratchet wheel 7. Due to the smaller path, which this safety catch 8 must travel back in comparison to safety catch 6 of the smaller ratchet wheel 5 in order to block the corresponding ratchet wheel 7, the total length of this safety catch 8 can also be somewhat smaller than that of the other safety catch 6.

1. A clamping device (1) for a nonskid tire chain with a housing (2) and an actuation member (3), which has a lock-in position, in which a clamping cord which can be pulled into the housing (2) through an opening in a housing, can be blocked counter to its clamping direction, as well as a release position, in which the blocking is canceled, and the clamping cord is connected inside the housing to a winding roller (4) which is preclamped in the winding-up direction, which [roller] is mounted in a rotatable manner around its axis (a), whereby a ratchet wheel on winding roller (4) is provided with at least one spring-loaded safety catch (6) that is assigned to it, is hereby characterized in that a second ratchet wheel (7) is provided with a spring-loaded safety catch (8) assigned to it and the two ratchet wheels (5, 7) are joined with one another in a way that resists rotation, whereby the blocking directions of ratchet wheels (5, 7) are opposite directions and the spring-loaded safety catches (6, 8) of the first or the second ratchet wheel (5, 7) can be engaged reciprocally with the ratchet wheels belonging thereto by means of a common actuation member (3).

2. The clamping device according to claim 1, further characterized in that the two safety catches (6, 8) are arranged in mirror images relative to a plane containing axis (a) of winding roller (4).

3. The clamping device according to claim 1 or 2, further characterized in that the first ratchet wheel (7) has a larger diameter than the second ratchet wheel (5).

4. The clamping device according to one of claims 1 to 3, further characterized in that the two ratchet wheels (5, 7) are produced in one piece from an injection-molded part.

5. The clamping device according to claims 1 to 4, further characterized in that the actuation member (3) embraces the ratchet wheels (5, 7) and the safety catches (6, 8) are mounted outside the actuation member (3), whereby the actuation member (3) has the shape of a cylindrical sheath interrupted at certain places which makes possible an engagement of the safety catches (6, 8) in ratchet wheels (5, 7).

6. The clamping device according to one of claims 1 to 5, further characterized in that projections (11) are provided as handles, projecting out from recesses in the housing (2) embracing the activation member (3) and the safety catches (6, 8), which [projections] are arranged opposite one another on the outer surface of the cylindrical actuation member (3), and these handles run essentially radially to the surface of the cylindrical sheath.

7. The clamping device according to one of claims 1 to 6, further characterized in that the actuation member (3) is mounted in housing (2) so that it can rotate around axis (a) of the winding roller (4).

8. The clamping device according to one of claims 1 to 7, further characterized in that the safety catches (6, 8) are mounted around axes (b) parallel to axis (a) of winding roller (4) so that they can tilt in housing (2).

9. The clamping device according to claim 8, further characterized in that a spring (14) successively taken up in recesses (19) of safety catches (6, 8) is provided in the mounting region of each safety catch (6, 8) in the housing (2).

10. The clamping device according to one of claims 1 to 9, further characterized in that the safety catches (6, 8) have ascending surfaces (16, 17) cooperating with specific places of the outer cylindrical surface of the actuation member (3) on their sides turned toward the actuation member (3), and these surfaces disengage the safety catches (6, 8) reciprocally from ratchet wheels (5, 7) against the respective spring (14) with a rotation of the actuation member (3).

11. The clamping device according to claim 10, further characterized in that the safety catch (8) assigned to the first ratchet wheel (7) larger in diameter has a raised part (18) on its ascending surface (16), and this raised part serves for creating a sufficiently great distance between ratchet wheel (7) and safety catch (8) in the release position.
